(19) United States
(12) Patent Application Publication
(10) Pub. No.: US 2012/0003614 A1
(43) Pub. Date: Jan. 5, 2012

(54) Eat Rite Baby

(76) Inventor: Kimberly Necole McBride, Huntsville, AL (US)

(21) Appl. No.: 13/089,256

(22) Filed: Apr. 18, 2011

Related U.S. Application Data
(60) Provisional application No. 61/342,641, filed on Apr. 19, 2010.

(51) Int. Cl. G09B 23/00

(52) U.S. Cl. 434/127

(57) ABSTRACT

The purpose of this invention, “Eat Rite Baby” is to offer its users a visual interpretation of how proper nutrition and exercise influences appropriate weight maintenance and health. This deed will be accomplished through physical and interactive methods. Sensors placed in the doll's open mouth will react to sensors in accompanying foods which will stimulate the doll into action, thus allowing a simulated weight gain and subsequent weight loss. These sensors will be located within a box that will allow for wires to extend through the baby's body in order to transmit signals to areas that will change. Additionally, the doll will be accompanied by a cd that will further instruct the user on how to live a healthier lifestyle via proper food selections, exercises, food group choices, portion sizes, etc.

### CROSS-REFERENCE TO RELATED APPLICATIONS

This invention serves as an extension of provisional patent 61/342,641 filed Apr. 19, 2010 and claims the benefit thereof. This application shall have the identical inventor as the claimed on the provisional application: Kimberly N. McBride

Childhood obesity is the result of an imbalance between calories consumed, metabolism, and physical activity that a child participates in. Other influences that have to be considered are genetic, behavioral, and environmental factors when speaking of this epidemic. The obesity rate among 2-4 year olds increased from 12.4% in 1998 to 14.6% in 2008. Children with high BMI's (Body Mass Index) often become obese adults which may put them at risk for high blood pressure diabetes, cardiovascular disease, and some cancers. Health concerns that may occur while they are still young include high blood pressure and high lipid concentration.

References cited

| | | |
|---|---|---|
| 5,067,924 | November 1991 | Munter |
| 5,167,561 | December 1992 | Rizzo |
| 6,413,142 B1 | July 2002 | Weastler |
| 4,828,528 | May 1989 | Chatkis |
| 4,259,807 | April 1981 | Siverstein |
| 4,236,347 | December 1980 | Fauls |
| 3,992,807 | November 1976 | Sapkus& Lewis |
| 2,154,121 | April 1939 | ? |

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

Appendix I

FIG. 1

FIG. 2

FIG. 3

FIG. 4

FIG. 5

### BACKGROUND OF THE INVENTION

This invention is toy related in general and a doll specifically. This doll will not only serve as an educational apparatus but an entertaining one as well. According to the discovered prior patents and prior art, main differences in this invention when compared to others are the interactive component and the usage of photoelectric sensors to activate movement within the doll.

### Prior Art

Through previously issued patents, it was discovered that similar dolls have been attempted. They were typically complex and required motors, cranks, or other mechanical systems in order to function.
U.S. Pat. No. 5,167,561 uses a selectively coupling chamber to simulate the weight adjustment. This chamber claims to operate by a pressure-raising or pressure-lowering device.
U.S. Pat. No. 5,067,924 required the addition or removal of “skin” in accordance to the owner's weight fluctuations. This doll performed in predetermined increments of weight fluctuation.
U.S. Pat. No. 6,413,142 B1 discloses an expandable doll that simulated child growth by the use of a manually operated air pump. This doll simulates the growth of a child from a baby to a toddler.
U.S. Pat. No. 3,992,807 discloses a growth simulating doll that shows the growth of a female from a pre-teen to a teenager. This doll shows the physical changes that occur in a female's body during this period of the life cycle.
U.S. Pat. No. 4,236,347 shows a flexible doll that is filled with a viscous liquid which stretches and deforms the doll's body.
U.S. Pat. No. 2,154,121 discloses a mechanical toy whose abdomen expands and contracts by use of a motor and crank.
U.S. Pat. No. 4,259,807 illustrates a fabric-sewn doll which will simulate weight fluctuation in the abdomen area with extendable arms and legs. Its intended usage was to simulate child growth. Additionally, U.S. Pat. No. 4,828,528 was also invented to illustrate child growth by utilizing a stretchable inner lining with an expandable core. This doll, however, was not intended to return to its original size.
The present invention will offer a lower cost, less cumbersome method of simulating weight fluctuation while instructing children on how to develop healthier eating habits.
This invention will also offer its users a chance to control the weight fluctuation of the doll and incorporate an interactive means by which to control the doll as well. The interactive component will further instruct the child on how to read food labels, food guide pyramids, control portion sizes, select healthier foods and proper kinds of foods in accordance with the FDA Food Guide Pyramid. In addition, the child will have a chance to ensure that the doll gets proper exercise and proper rest by choosing the exercises that the doll will participate in at any particular time. Additionally, the user will be able to put the doll to “bed”. It is widely known that part of a healthy regime is getting the appropriate amount of rest nightly.

### BRIEF SUMMARY OF THE INVENTION

The general idea of this invention is to instruct children and parents on healthy eating and exercising habits. This will be accomplished by offering visual, interactive, and “hands-on” methods of teaching the repercussions of an “unhealthy” nutritional regimen and idle lifestyle.

One specific advantage of this invention is allowing the user to have “control” over the diet of the doll, ultimately controlling when, what, and how much the doll eats and how much weight is gained. Equipping the user with t his perceived “control” will enable the child to make healthier choices and have some control (some influence on parents food choices) over their own diet. Additionally, the child will learn healthier eating habits at a young age which will manifest itself during adolescence and adulthood.

### BRIEF DESCRIPTION OF THE SEVERAL VIEWS OF THE DRAWING

FIG. 1

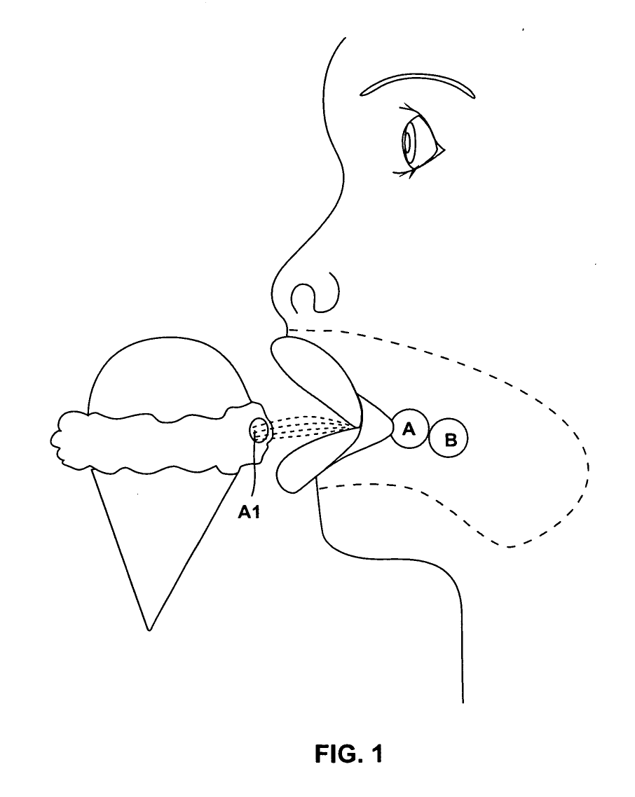

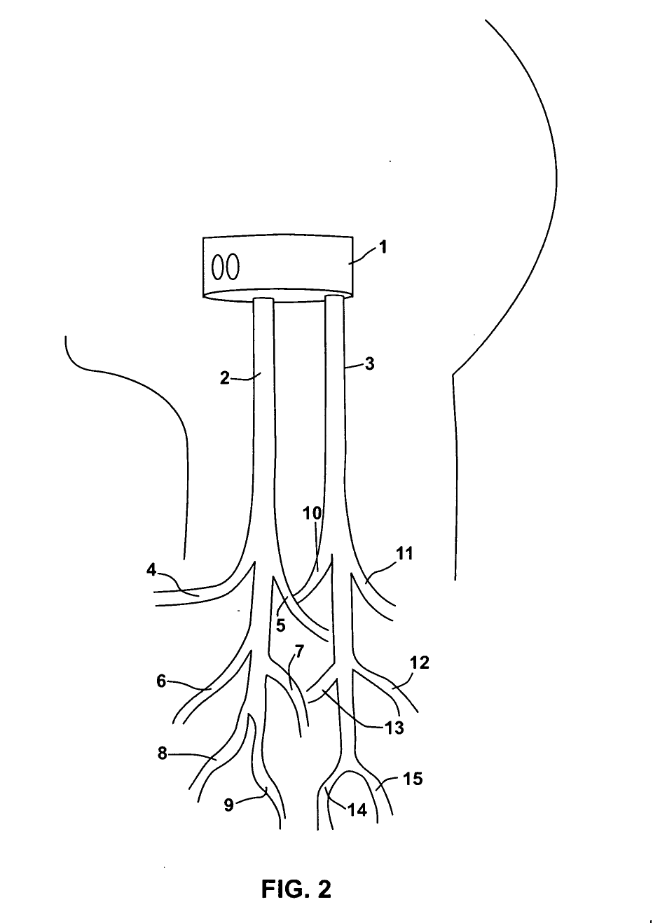

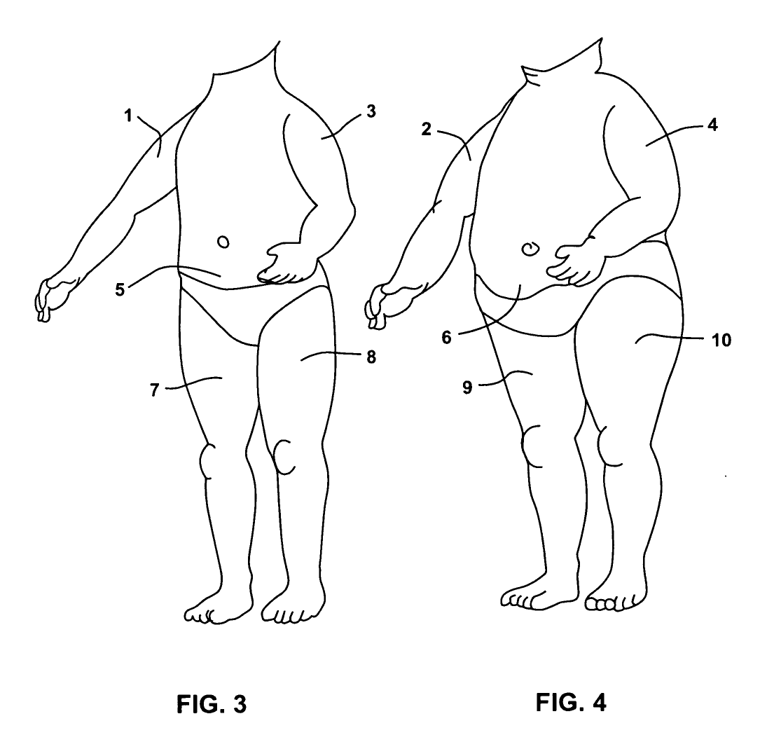

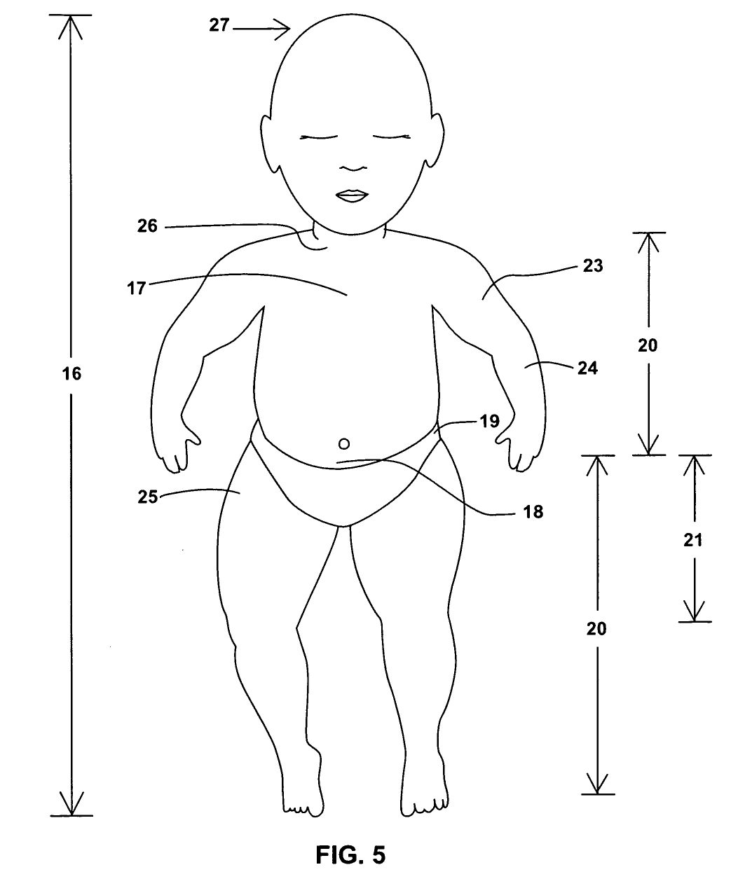

Doll's mouth will contain a box with 2 sensors A & B. Each of the accompanying foods will contain aggregate sensors. In FIG. 1, the ice cream cone is utilized to represent an “unhealthy” food. This food has an aggregate sensor (A1) placed in the side. When the user places the unhealthy food (ice cream cone) up to doll's mouth, sensor A is activated and sends signals through wires to sensors located in designated areas (upper arms, upper legs, and abdomen) therefore causing the simulated weight gain. Additionally when a healthy food is utilized the same way, sensor B will send signals through abutting wires to same designated areas causing weight loss.

FIG. 2

After sensor is activated inside of dolls mouth, through the one of the sensors located in mouth box(1), a signal will travel down the wire labeled (2) if a healthy food and the one labeled (3) if it is a unhealthy food. The signal will then travels through wire (4) to upper right arm and (5) to upper left arm (6) and (7) to the abdomen, and (8) and (9) to upper right and left leg. This signal will simulate weight loss if doll is at extension or no movement if doll is at normal weight. Similarly when an unhealthy food if given to doll the signal is activated through mouth box (1), a signal then travels down wire (3) activating (10) and (11) going to upper right and left arms, (12) and (13) leading to the abdomen, and (14) and (15) leading to the upper right and left legs.

FIG. 3 and FIG. 4

This figure represents the doll at normal weight or contraction (if doll is at extension). Part (1) represents the “normal ” size upper right arm. (2) represents the extended (overweight) version of the upper right arm. Additionally (3) represents a normal upper left arm, while (4) represents the extended upper left arm. Part (5) is the regular sized abdomen, while (6) is the extended version. (7) and (8) represent the normal sized upper right and left legs, respectively, while (9) and (10) represents the extended version of both.

FIG. 5

This figure represents the normal sized baby with all areas stable.

Appendix 1

Appendix 1 represents a flow chart of the accompanying educational cd. This is further explained in the detailed description of the invention.

### DETAILED DESCRIPTION OF THE INVENTION

The intended invention is multi-faceted. Its main objective is to instruct children on how to make healthy nutritional decisions. They will be able to visually see the effects of healthy and unhealthy food choices on the body. The simulation of the usage of the doll will equip children and their caretakers with the knowledge of effectively choosing proper diet and exercise regimens.

The invention is a doll that will expand and contract in order to simulate weight gain, loss, and maintenance depending upon the amount and types of food that the doll is fed. The doll will be made of a stretchable, synthetic vinyl that will allow for contraction and expansion. The vinyl will be thinner in the areas where expansion and contraction are to take place. Two types of photo-electric sensors will be placed inside doll's mouth. One type of sensor will “read” the sensors that are placed inside the healthy foods. The doll's weight will stay the same or it will contract (depending upon if doll is at expansion or not). The alternate type of sensor will “read” the sensors that are located within the unhealthy food. This sensor will cause weight gain for the doll. A box containing the sensors and wire attachments will be placed inside of doll's mouth. Wires will be attached in order to transmit signal from sensors in mouth to sensors located in various parts of the doll's body. It will contain miniature air bladders located in the areas where weight will fluctuate. The expansion and contraction of these bladders will be activated by the reaction of the sensors in order to produce desired effect. Once the sensors are activated, a signal will travel from the sensor in doll's mouth to the upper arms, upper legs, and abdomen of the doll through wires. The weight and size fluctuations would occur in the abdomen, upper arms, and upper legs of the doll.

The “good” foods will consist of broccoli, chicken, eggs, apples, bananas, grains, and other healthy recommended options from the food guide pyramid. The “bad” foods will consist of but not be limited to candy, hamburgers, French fries, snack cakes, and other unhealthy food choices. Sodas, fruit drinks, water, fruit juices, and other beverage choices will also be included. These beverages will contain sensors that produce a similar reaction for the doll.

The doll will be a medium sized doll approximately 18 inches in length, with other measurements as follows (See FIG. 5):

Chest—10 inches in width—expands to 13 inches

Waist—9.5 inches in width—expands to 12.5 inches

Hips—10 inches—expands to 13 inches

Neck to Waist—3.5 inches

Waist to knees—5 inches

Waist to ankles—7 inches

Upper arm circumference—2.75 inches—expands to 4.75 inches

Forearm circumference—4.5 inches

Thigh circumference—3.5 inches—expands to 5.5 inches

Neck circumference—8 inches

Head circumference—12 inches

These measurements are to be used as a guide only. The doll will only expand through the abdomen, upper arms, and thigh area. These are the most notable areas of weight gain in humans.

Additionally, the doll will contain a pedometer that resembles a watch located on wrist. This apparatus will measure the number of steps that the child took on any particular day which will equate to how many steps the doll took (translating into exercise for the child). The child will be able to keep track of the number of steps on an exercise log that will be included in the interactive aspect of this toy.

Another part of this invention includes the interactive component. A cd will accompany the doll. The cd will consist of activities related to maintaining a healthy diet and exercise routine. This apparatus will operate following the following method (see Appendix I):

CD in placed in computer: when mechanism is activated it, it will give the user the option of registering their doll by selecting “New” or “Returning User”. The user can create a new doll or delete one that has been used previously and create another doll. The user will also be able to name their doll. During registration, the user will be prompted to include their name, address, email address (to receive future additions and updates to doll). This interactive doll, which the user created, will guide them through the entire program. This section will also include a BMI calculator in order to educate parents where their child is on the scale and how the parent and child can work towards reaching and/or maintaining a healthy BMI. Included here will be a BMI calculator in order for child to figure their Body Mass Index and see how it compares.
After the creation of their doll, a menu will appear that offers four options: Feeding Time, Exercise, Games, and Bed Time (note Appendix I).

Feeding Time:

Feeding Time will contain the food guide pyramids, plate sizes, and portion sizes. Child will be able to “fix” their plate according to recommended portion sizes for their particular age. They will also be allowed to choose snacks (healthy and unhealthy) and beverages (sodas, water, fruit drinks, shakes, etc.).Additionally there will be food labels—teaching parents how to read food labels and how much of each nutrient their child needs daily.

Children will be able to place food items in the appropriate place on the food pyramid. This activity will teach them what food products belong where and how many servings they are required to ingest from each food group.

Exercise:

During the exercise phase the simulated doll on the computer will show the proper way to perform exercises i.e. jumping jacks, jumping rope, skating, trampoline, bicycle riding—with activities that require safety equipment, the simulated doll will show the proper way to use safety equipment (helmets, pads, etc) The child will be able to keep a count of how much exercise is done daily, for instance 10 jumping jacks, 20 mins of trampoline, etc. This section will also contain a log that the child and parent can maintain according to the pedometer that is located on dolls wrist. This action will simulate how much “exercise” the doll and ultimately the child, received.

Games:

The interactive component will consist of food mazes, crossword puzzles, dot-to-dots, and other food-related games in order to offer the children “fun” ways to view food and exercise. They will also be able to view and create proper portion sizes and plate separations. How to read, interpret, and follow food labels will be presented in a kid-friendly manner.

Bed Time:

Since proper rest is important in maintaining health, the child will be able to put doll to bed. This will be done in a celebratory manner in order to try to remove some of the apprehension that some children develop when time to go to sleep.

The cd will also contain age appropriate music, sound effects, and animation in order to pique the interest of the user and enhance the learning experience.
It is the intention of the inventor to “allow” for dolls of older children to develop maladies that may accompany obesity. These may include high blood pressure, some forms of cancer, arthritis, etc. These children would have to attempt to control these conditions by administering some medications, adjusting and adhering to a condition-specific diet, proper exercising routines, etc. These experiences will teach the children the relationship between a healthy diet while you're young and what could develop latter in life. This addition will be introduced into the invention at a later date.

1. A doll that simulates weight loss and gain by the expansion and contraction of particular parts of the body, the doll will be comprised of the following:
a doll made of a stretchable vinyl that is thinner (than the remaining portions of the doll) throughout the abdomen, upper legs (thighs) , and upper arms to simulate weight gain and loss;
a doll that contains miniature air bladders (with sensors located within) that receive signals from the sensors in mouth that will expand or contract once sensors are activated in order to cause the simulated fluctuation in weight,
a doll with photoelectric sensors placed inside mouth of doll and inside the accompanying foods, with a positive sensor that reads the healthy foods which will cause weight maintenance or weight loss if doll is at extension once signal is sent from sensor located in mouth to the parts of the body that will simulate the weight change;
a doll with negative sensors placed inside the mouth as well as in unhealthy foods which after contacting sensors in mouth, will cause weight gain in the stated areas of the doll again through the use of a signal that also travels to the parts of the body that will simulate weight change;
The invention in claim 1 will simulate a human figure that when fed a healthy diet regimen will teach children how to make healthier food choices by visual and hands-on methods;
The invention in claim 1 will simulate a human figure that when fed an unhealthy diet regimen will teach children what making unhealthy food choices can induce on the human body;

2. The invention in claim 1 will be accompanied by a stand-alone pedometer in the form of a watch on the wrist of the doll; whose main purpose would be to allow the child to monitor the number of steps taken by the child and the doll in a particular day; thus equating to the amount of exercise the doll was exposed to;

3. The doll will be accompanied by a cd-rom which will allow for interactive teaching and learning for the user; the cd-rom will further instruct child on how diet and exercise effect overall health; the claims of the accompanying cd are as follows:
a. The cd will open with giving user the option of registering themselves and their doll; the user will then have the option of creating their own doll, this doll will serve as a guide through the remainder of the program;
b. A menu will appear granting the user a choice of 4 options, including feeding time, exercise time, game time, and bed time;
c. Feeding time for the item in claim 3 will consist of the food guide pyramids, plate sizes, and portion sizes. User will be able to “fix” their own plate. They will also be allowed to choose snacks (healthy and unhealthy) and beverages (sodas, water, fruit drinks, shakes, etc. parents will learn how to read food labels and how much their child needs daily;
d. Exercise option in claim 3 will consist of simulated doll on the computer which will show the proper way to perform exercises (jumping jacks, jumping rope, skating, trampoline, bicycle riding); activities that require safety equipment, the simulated doll will show the proper way to use safety equipment (helmets, pads, etc), additionally the child will be able to keep a count of how much exercise is done daily and a log from the pedometer located on dolls wrist;
e. Games option in claim 3 will consist of games that are nutrition related: crossword puzzles, mazes, nutrition sleuth (find the missing fruit or meat), dot-to-dot, further educating users on making healthy food choices;
f. Bed time option for claim 3 will consist of putting the doll to sleep, proper rest is important in maintaining a healthy lifestyle. Child will choose an appropriate time for the doll to retire and compare that with his/her own bedtime.
